(19) United States
(12) Patent Application Publication
(10) Pub. No.: US 2014/0376374 A1
(43) Pub. Date: Dec. 25, 2014

(54) SYSTEMS AND METHODS FOR SELF-ORGANIZING NETWORKS WITH SMALL CELLS

(71) Applicant: Public Wireless, Inc., San Jose, CA (US)

(72) Inventors: Brett Moser, Atascadero, CA (US); Quang Huy Nguyen, Los Altos Hills, CA (US); Zhanhe Shi, San Jose, CA (US); Nart Bajj, Canyon Country, CA (US)

(21) Appl. No.: 13/926,772

(22) Filed: Jun. 25, 2013

(51) Int. Cl. H04W 84/18; H04L 12/803

(52) U.S. Cl. CPC H04W 84/18; H04L 47/125
USPC 370/235; 370/329

(57) ABSTRACT

A multi-modal multi-modulation small cell base station such as a picocell is disclosed. The small cell can perform operations to form a self-organizing network. Portions of the small cell, for example, in a processor module, that provide function for SONs may be referred to as a SON module. The SON module may provide a configurable set of algorithmic optimizer components to tune various aspects of network performance. The SON module may provide functions such as a tracking area optimizer, a random access channel (RACH) optimizer, a mobility optimizer, a load balancer, and an inter-cell interference coordinator (ICIC).

### BACKGROUND

The present invention generally relates to the field of wireless communication systems and to systems and methods for self-organizing networks with small cells.

Growth in wireless communication continues to increase. Demand for data services with high data bandwidth requirements has led to the introduction of many techniques to increase bandwidth. Deployment of small cells, such as picocells and femtocells, has become increasingly desirable for providing coverage. Small cells may be deployed, for example, in areas having high user density, such as airports or event venues. A small cell deployment typically has a 100 meter to 1 kilometer radius. Development and deployment of a large-scale network is complex. Network organization grows increasingly complex as an increasing number of cells are deployed.

### SUMMARY

In one aspect, the invention provides a base station that includes: a plurality of radio devices operable to establish wireless communications with user equipments; a backhaul interface module configured to send data to a core network and receive data from the core network; and a common radio element application manager (CREAM) module configured to manage communications between the user equipments and the core network via the radio devices and the backhaul interface, the CREAM module including a self-organizing network module configured to configure the base station to operate in a self-organizing network.

In another aspect, the invention provides a base station that includes one or more radio modules, each of the radio modules operable to establish wireless communications with user equipments using one or more managed cells; a backhaul interface module configured to send data to a core network and receive data from the core network; a processor; and a memory coupled to the processor and storing instructions for execution by the processor, the instructions comprising a self-organizing network module that when executed by the processor configures the base station to operate in a self-organizing network.

Other features and advantages of the present invention should be apparent from the following description which illustrates, by way of example, aspects of the invention.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a diagram of a wireless communications network in accordance with aspects of the invention;

FIG. 2 is a functional block diagram of a small cell in accordance with aspects of the invention;

FIG. 3 is a functional block diagram illustrating aspects of a self-organizing network module in accordance with aspects of the invention;

FIG. 4 is a flowchart of a process for optimization decision triggering in accordance with aspects of the invention; and

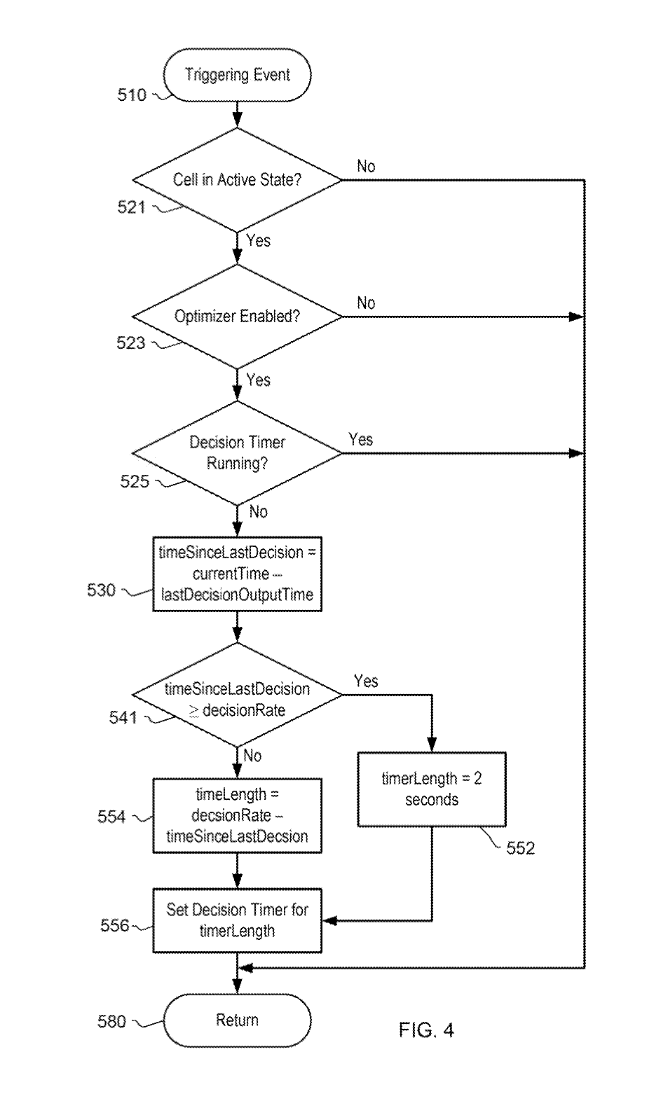

FIG. 5 is a flowchart of a process for producing optimization decisions in accordance with aspects of the invention.

### DETAILED DESCRIPTION

The systems and methods disclosed herein can be used with small cells and other base stations. Small cells can be operated in a wireless network to provide wireless network connectivity to a plurality of user devices. The small cell can cooperate with other devices in the wireless network to self-organize to efficiently provide communication services. Network with such operations are commonly referred to as self-organizing networks (SON). The systems and methods disclosed herein may be used to operate SONs. For concise exposition, various embodiments are described using terminology and organization of particular technologies, standards, and services. However, the systems and methods described herein are broadly applicable to other technologies, standards, and services.

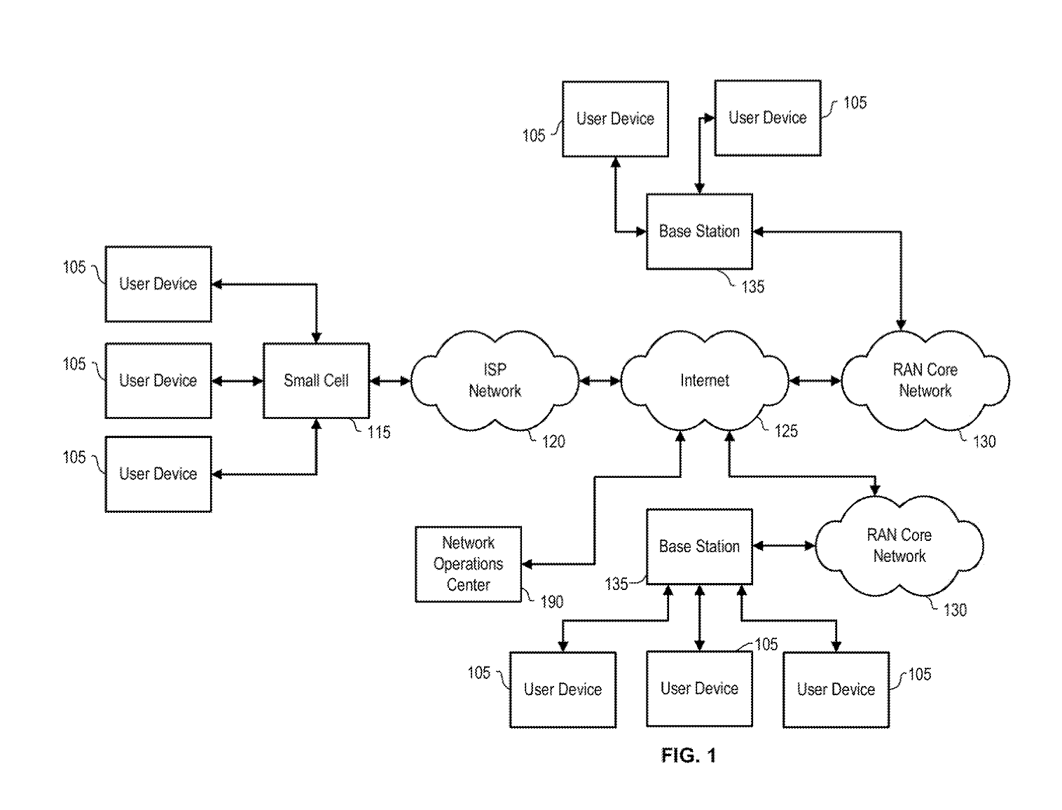

FIG. 1 is a block diagram of a wireless communications network. The wireless communications network includes a small cell 115. The small cell 115 is a small base station and may be deployed to provide coverage for a smaller area than a traditional, or macro, base station. The small cell may also be termed, for example, a small form-factor cell, femtocell, or picocell. The small cell 115 may, for example, provide coverage for an office building, hotel, condominium complex, shopping mall, airport, train station, or event venue. Small cells may be used to fill in coverage in indoor environments where signals from outdoor macro base stations do not easily reach. Small cells may also be used to add network capacity in areas where dense mobile device usage can be present, such as airports, train stations, and sports or concert venues.

The small cell 115 may be configured to provide coverage for one or more mobile phone carriers or network providers. The small cell 115 communicates with a radio access network (RAN) core network 130 via a broadband connection provided by an Internet service provider (ISP) network 120. The ISP network 120 provides a backhaul connection for the small cell 115. The ISP network 120 may communicate with the RAN core network 130 directly or indirectly via the Internet 125. The RAN core network 130 provides telecom services to user devices 105. Each of the user devices 105 is subscribed to a respective network provider associated with the RAN core network 130. Some of the user devices 105 may be mobile communication devices, such as mobile phones, wireless modems, or other device that use voice, data, or other communications services. Other user devices 105 may be fixed location devices. Various ones of the user devices 105 may be associated with different network providers and may communicate using different frequencies and communication protocols.

The small cell 115 receives data from the RAN core network 130 via the ISP network 120 and transmits the data to one or more of the user devices 105. The small cell 115 also receives data from the user devices 105 and transmits the data to the RAN core network 130 via the ISP network 120. Alternatively, the small cell 115 may communicate directly with the RAN core network 130.

The small cell 115 can include one or more radio devices that can be remotely configured by a network administrator. The radio devices (and other functions of the small cell) may also be automatically configured. The radio devices may be configured to operate using various frequencies (or bands) and communication protocols (or modulation techniques). The radio devices of the small cell may be reconfigured based on demand. Furthermore, the small cell can include extra radio devices beyond what is forecast for current coverage needs. The extra radio devices allow the small cell's capabilities to expand to provide service to a larger number of subscribers and/or carriers. The extra radio devices may also be used as backups that are activated if monitoring systems implemented for the small cell detect that a radio device has failed. Providing reconfigurable radio devices and extra radio devices can provide cost savings by reducing the need for a technician to be deployed into the field to service the small cell.

The wireless communications network also includes base stations 135. The base stations 135 communicate with the RAN core network 130 and also provide coverage to the user devices 105. The small cell 115 may provide coverage in an area that overlaps with coverage areas of the base stations 135. FIG. 1 has been simplified for ease of explanation and a wireless communications network may include additional elements including a plurality of small cells. A wireless communications network may also include additional communication paths. The base station 135, as well as the small cell 115, may also be referred to a node B or an evolved node B (eNodeB or eNB). Features described for the small cell 115 may generally also be performed by, included in, or otherwise associated with the base stations 135 and vice versa.

The wireless communications network also includes a network operations center (NOC) 190. The NOC 190 may be used for managing operation of the small cell 115. A system administrator can remotely configure the small cell 115. According to an embodiment, system administrators can also monitor and manage the network or networks providing backhaul connectivity to the small cell 115.

The small cell 115 can perform operations to from a self-organizing network. For example, the small cell 115 may provide a configurable set of algorithmic optimizer components to tune various aspects of network performance. In particular, the small cell 115 may perform functions such as a tracking area optimizer, a random access channel (RACH) optimizer, a mobility optimizer, a load balancer, and an inter-cell interference coordinator (ICIC).

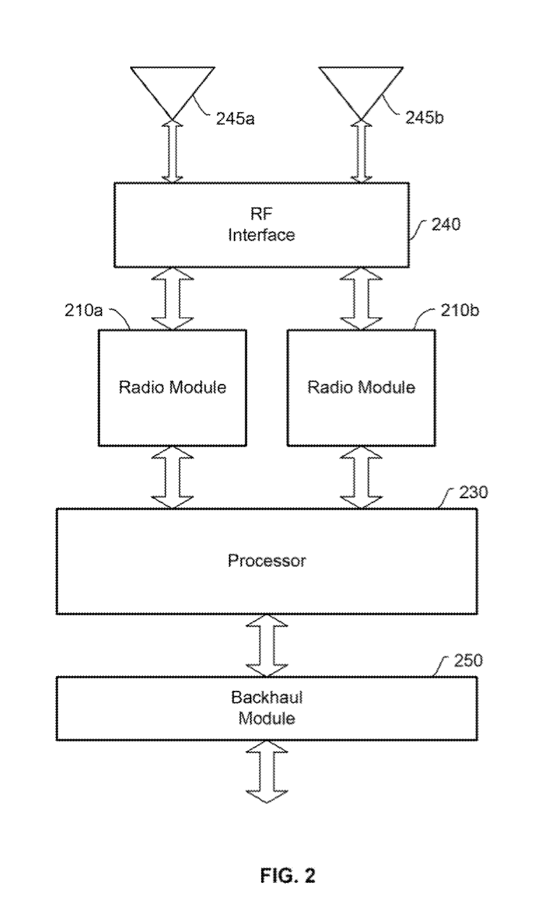

FIG. 2 is a functional block diagram of a small cell. The small cell may be used to implement the small cell 115 of FIG. 1. The small cell of FIG. 2 includes a radio frequency (RF) interface module 240, a backhaul interface module 250, and a processor module 230. The small cell illustrated in FIG. 2 includes two radio modules 210. However, in other embodiments, the small cell may include greater or fewer radio modules. For example, a small cell deployed in an area that is anticipated to have a high concentration of user devices during peak usage may include more radio modules than a small cell deployed in an area that is anticipated to have a low concentration of user devices. The processor module 230 provides an interface that allows a small cell to include multiple radio modules 210 and to manage the interaction of the radios.

The RF interface module 240 provides an interface for radio signals to and from the small cell. The RF interface module 240 couples the radio modules 210 to antennas 245. The small cell illustrated in FIG. 2 includes two antennas 245. In other embodiments, the small cell may include greater or fewer antennas. Additionally, the number of antennas may differ from the number of radio modules. The antennas 245 can include a broadband antenna used for transmitting and receiving in the frequency bands that are used for mobile communications. The RF interface module 240 includes circuitry for transmission and reception of the radio signals such as power amplifiers for driving the antennas, low noise amplifiers (LNAs) for amplifying signals received by the antennas, tuners, upconverters, and downconverters.

The RF interface module 240, in some embodiments, combines and splits the radio signals. For example, the small cell may be configured for MIMO or diversity operation. Additionally, the RF interface module 240 may operate in multiple frequency bands. The RF interface module 240 may include modules that are dynamically configurable or adjustable. For example, a power amplifier in the RF interface module 240 may be configured for various predistortion techniques and may have an adjustable bias setting.

Each of the radio modules 210 may be configured to support a specific protocol stack. The protocol stack may include, for example, a Radio Resource Control (RRC) layer, a Packet Data Convergence Protocol (PDCP) layer, a Radio Link Control (RLC) layer, a Media Access Control (MAC) layer, and a Physical (PHY) layer. The protocol layers of the radio modules 210 may differ and allocation of functions over the layers may also differ.

The Radio Resource Control (RRC) layer handles the control plane signaling of Layer 3 between the user devices and the Universal Terrestrial Radio Access Network (UTRAN). The UTRAN allows connectivity between the UE and the core network. The UTRAN includes base stations (eNodeBs) and Radio Network Controllers (RNCs). The RRC layer provided functions for connection establishment and release, the broadcast of system information, radio bearer establishment/reconfiguration and release, paging notification and release, and outer loop power control.

The Packet Data Convergence Protocol (PDCP) layer performs IP header compression and decompression, transfer of user data and maintenance of sequence numbers for Radio Bearer.

The Radio Link Control (RLC) layer delivers data to the MAC layer over logical channels. The RLC layer maps these logical channels to transport channels that represent the interface to the physical layer. The RLC layer can provide error correction and can also ensure that data is delivered only one time and in the correct sequence. The RLC layer can also segment data packets delivered by higher layers so that the MAC sublayer receives data of the correct size over the logical channels.

The Media Access Control (MAC) layer coordinates access to the physical medium over which data is transmitted. The MAC layer can include queue in which data for different data streams can be placed until the data is transmitted.

The Physical (PHY) layer provisions transport channels, maps transport channels to the physical interface, provides macro diversity and soft handover. The physical layer can also provide error protection, such as forward error correction and interleaving. The physical layer can also provide for multiplexing and demultiplexing, frequency and time synchronization, power control, and measurements of various characteristics of the physical link, such as frame error rate.

The radio modules 210, in some embodiments, may be configured to implement different protocol stacks. For example, in the embodiment illustrated in FIG. 2, the first radio module 210a may be configured to implement a UMTS protocol stack and the second radio module 210b may be configured to implement a long term evolution (LTE) protocol stack. The radio modules 210, in some embodiments, can be reconfigured dynamically based on the types of user devices being served by the small cell. Additionally, one or more of the radio modules 210 may operate to sense radio signals received by the small cell. The small cell may use information about sensed signals, for example, to determine frequencies to transmit on.

The radio modules 210 may be provided as software-defined radios (SDRs). An SDR is a programmable radio device that includes a processor for executing signal processing. A variety of different radio protocols (waveforms) can be received and transmitted depending on the software that is executed by the processor of an SDR. An SDR can be rapidly reconfigured to change radio protocols used. In an embodiment, processing circuitry may be shared between radio modules and between radio modules and other modules of the small cell.

The processor module 230 provides processing resources for the small cell. The processor module 230 can process communications being received and transmitted by the small cell. The processor module 230 can also manages resources of the small cell. The processor module 230 includes or is coupled to a storage module. The storage module stores data for use by the processor module. The storage module may also be used to store computer readable instructions for execution by the processor module 230. The computer readable instructions can be used by the small cell for accomplishing the various functions of the small cell. The storage module or part thereof may be considered a non-transitory machine readable medium. For concise description, the small cell or embodiments of it are described as having certain functionality. This functionality, in various embodiments, is accomplished by the processor module 230, other modules, or a combination of modules. Furthermore, in addition to executing instructions, the processor module 230 may include specific purpose hardware to accomplish some functions.

The processor module 230 can manage radio resources of the small cell. The processor module 230 provides an interface that allows the small cell to include a plurality of the radio modules 210. The processor module 230 provides functions for a common radio element application manager (CREAM). Particular features of embodiments of the processor module 230 are described in more detail in other sections of the application.

The backhaul interface module 250 provides an interface to backhaul communications for the small cell. The backhaul connections may vary, for example, depending on the type of network that the small cell will be connected to. For example, the backhaul interface module 250 may include a Data Over Cable Service Interface Specification (DOCSIS) connection, an Asymmetric Digital Subscriber Line (ADSL) connection, a Very-high-bit-rate Digital Subscriber Line (VDSL) connection, a satellite connection, or an optical fiber connection. In some embodiments, the backhaul interface module 250 includes connections for multiple backhaul interfaces. Data received from the network is supplied to the other modules of the small cell via the backhaul interface module 250. Similarly, data from the modules of the small cell is transmitted to the network via the backhaul interface module 250. The backhaul interface module 250 may also provide power distribution and control, environmental monitoring, and local and remote system management support for the small cell.

The small cell can perform operations to form a self-organizing network. Portions of the small cell, for example, in the processor module 230, that provide function for SONs may be referred to as a SON module. The SON module may provide a configurable set of algorithmic optimizer components to tune various aspects of network performance. By way of introduction, the SON module may provide functions such as a tracking area optimizer, a random access channel (RACH) optimizer, a mobility optimizer, a load balancer, and an inter-cell interference coordinator (ICIC).

The SON module may support multiple cells. In an embodiment, the SON module supports six cells. The functions of the SON module may be configured, including enabling or disabling and selection of the algorithms used, for individual cells. A data model may be used to configure the SON module.

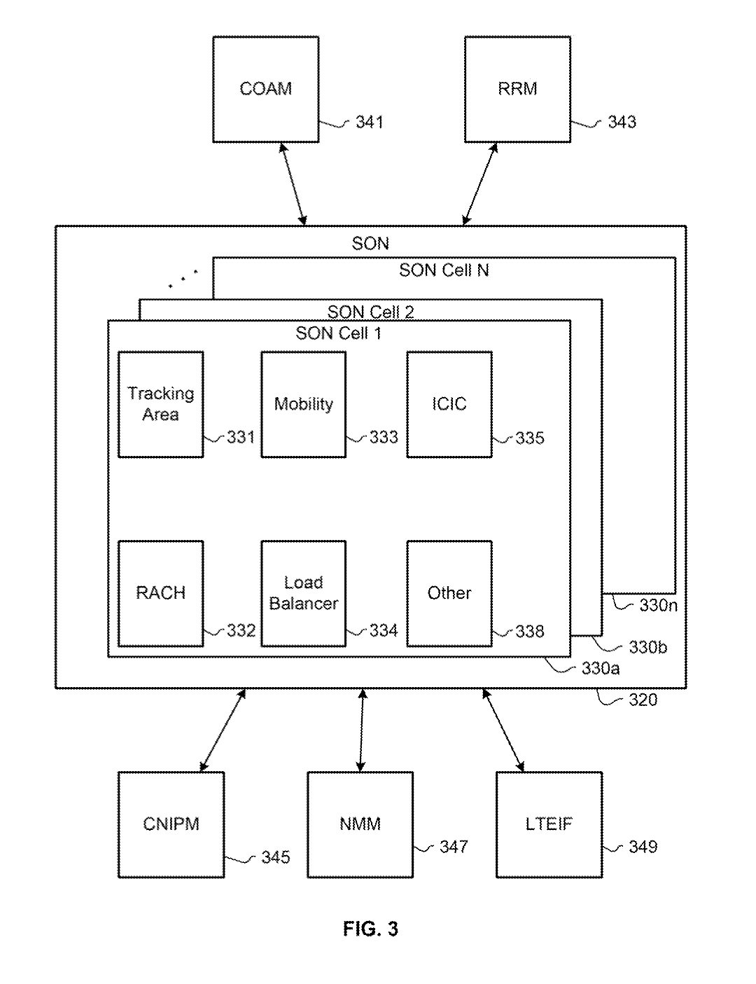

FIG. 3 is a functional block diagram illustrating aspects of a self-organizing network module. The SON module of FIG. 3 may be used, for example, with the small cell of FIG. 2. The SON module 320 includes interfaces for communication with other modules of the small cell. The SON module 320 includes an interface to a common operation and alarm management (COAM) module 341. The SON module 320 also includes an interface to a radio resource management (RRM) module 343. The SON module 320 also includes an interface to a core network and inter-small cell management (CNIPM) module 345. The SON module 320 also includes an interface to a network monitor mode (NMM) module 347. The SON module 320 also includes an interface to a LTE interface (LTEIF) module 349. In an embodiment, the SON module 320 may include additional interfaces that are not illustrated in FIG. 3. The SON module 320 may, for example, receive configuration information over the interfaces and may provide information about its operational status over the interfaces. Modules referred to as observers may be used to receive information from the SON module. Aspects of the interfaces with other modules will be described below with the descriptions of the related SON functions.

Many functions of the SON module will be described as being performed by software modules executed by a processor. The functions may also be performed by hardware modules or a combination of hardware and software modules.

The SON module 320 includes multiple modules that provide specific functions. Various modules may, for example, operate to optimize particular network aspects. Some modules may, for example when implemented as computer processes, create and terminate other modules. The SON module 320 can include per-cell modules that provide functions for each of multiple cells supported by a base station. Each cell may, in various embodiments, support different technologies, be associated with a different coverage area, or a combination thereof. The SON module 320, in an example embodiment, supports up to six cells. Each of the cells has an associated per-cell SON module 330a-330n.

In the embodiment illustrated in FIG. 3, the per-cell SON modules include a tracking area optimizer module 331, a random access channel (RACH) optimizer module 332, a mobility optimizer module 333, a load balancer module 334, and an inter-cell interference coordinator (ICIC) module 335. The SON module 320 may also include modules for optimizing other network aspects. This is represented in FIG. 3 by an other module 338. The SON module 320 can initialize the modules that the SON module 320 includes and provide interfaces to those modules. For example, when the SON module 320 receives configuration parameters or operating information, the SON module 320 can pass the data to the appropriate modules. Parts of the SON module 320 including the optimizer modules may be implemented on a per cell basis.

The SON module may operate in multiple states. The state can be different for each cell. In an embodiment, the states include an active state, an inactive state, and a test state. Components of the SON module may have similar states. The state may be controlled, for example, by a configuration file or an operations, administration, and maintenance (OAM) command. In an embodiment, the state is set by an OperationMode data model parameter.

The SON module generally begins in the inactive state. The inactive state continues during initialization and configuration. While in the Inactive State, the SON module will ignore input data from other modules except for configuration settings from the COAM module. In the inactive state, the SON module will not make any optimization decisions. The SON module will also be in the inactive state during shutdown.

The SON module can receive an indication from the RRM module to activate. The RRM module can signal this when it determines that it is ready for the SON module to start making optimization decisions. The SON module may, for example, receive the indication to activate via an OAM command, for example, an addManagedCell( ) function. The addManagedCell( ) function signals the SON module to active for a particular cell or cells. Depending on the OperationMode parameter value, the SON cell will transition to the test or active state or remain in the inactive state. In the active state, one or more of the optimizer modules may be inactive.

The SON module can receive an indication from the RRM module to transition to the inactive state. The SON module may, for example, receive the indication to go inactive via an OAM command, for example, a removeManagedCell( ) function. In the inactive state running DecisionPending timers are stopped. Additionally, functions may destroy modules to free the associated resources for other uses.

In the active state, SON modules receive and process input data and configuration setting changes. The use the input data and configuration settings to make optimization decisions. The optimization decisions are supplied to the other CREAM modules. Operations of the SON module may also be logged.

The test state is similar to the Active State. In the test state, however, optimization decisions are not sent to other modules. Log messages generated in the test state can be used, for example, for development and system analysis.

Before the SON module begins network operations, it initializes. Initialization can include creating processes, interfaces, and data structures for each cell for which the SON module provides services. The SON module, in an embodiment, limits the number of cells and the number of optimizer modules per cell, for example, based on computational and memory resources. Most communications on the SON module's interfaces specify a cell the communication applies to. The cell may be specified by an index referred to as SonCell. The SonCell distributes the calls to each of the current optimizers for the specified cell.

The SON module 320 has many operational parameters. Some parameters may apply to the SON module as a whole, some to SON for a specific cell, and others to specific optimizer modules for a cell. If there is more than one optimizer defined for a module (e.g., multiple optimizers that may be used for load balancing), a configuration parameter can specify which optimizer to use.

The parameters, in an embodiment, are initialized from a configuration file. During startup, the COAM module reads the configuration file and passes the parameters to the SON module 320. For parameters that are not provided, default values are used. The COAM module may also pass configuration parameter updates to the SON module 320 after start up, for example, during the test and active states. Parameter updates may occur due to requests from OAM clients. If the SON module 320 changes any of the configuration parameters, it may save the parameters for future use. The parameters can be saved by passing them back to the COAM module.

Many SON functions use information about neighboring base stations. The SON module 320, in an embodiment, maintains one or more neighbor lists. A separate neighbor list is often maintained for each cell. Individual optimizer modules can keep their own neighbor lists with data specific to their functions. The SON module 320 can receive information about neighbors from the RRM module 343. For example, the RRM module 343 may call a neighborPresentInd( ) function to indicate that neighbor is present and a neighborNotPresentInd( ) function to indicate that neighbor is not present.

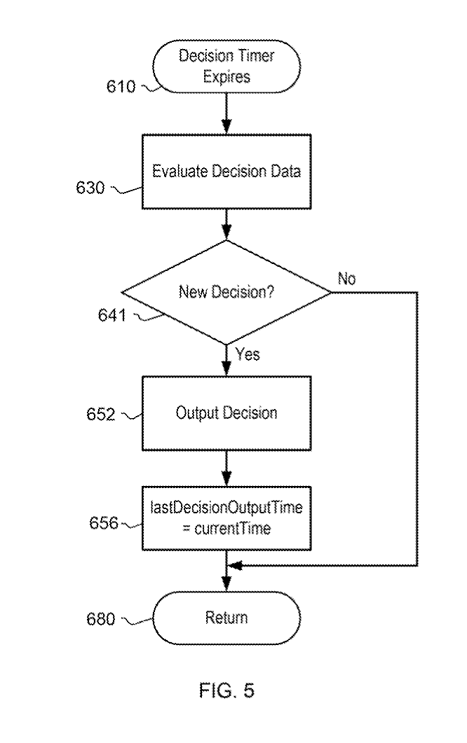

Some aspects of the optimizer modules can be common without regard to the particular optimization performed. The optimizer modules can, for example, use a common method to determine when optimization decisions are made. FIG. 5 is a flowchart of a process for decision triggering. The process uses a decision timer to determine when optimization decisions are made. The decision timer, in an embodiment, can be set to a time value from the decision timer counts down to zero (expires). Using the decision timer allows the process to meter the rate of decision outputs. That is, optimization decisions may not be made immediately. Metering or delaying decisions can avoid ping-ponging, or oscillating between offset decision outputs.

The process may begin when a triggering event occurs 510. The triggering events are occurrences that can cause an optimization decision to be output. Example triggering events include when input data arrives that is relevant to the particular optimizer, when relevant configuration parameters are changed, or when an optimization value exceeds a threshold. A periodic timer may also be used to trigger the process.

In step 521, the process checks that the cell associated with the optimizer module performing the process is in the active state. If the cell is in the active state, the process continues to step 523; otherwise, the process returns.

In step 523, the process checks that the optimizer module performing the process is in enabled. If the optimizer module is enabled, the process continues to step 525; otherwise, the process returns.

In step 525, the process determines whether the decision timer is running. If the decision timer is already running, the process does not need to take further action to set the timer. If the decision timer is running, the process returns; otherwise, the process continues to step 530.

In step 530, the process determines how long ago the previous optimization decision was made. The process may, for example, set a timeSinceLastDecision value to equal a currentTime value minus a lastDecisionOutputTime value, where currentTime is the time the process is performing the step and lastDecisionOutputTime is the time when the previous decision output was produced. The lastDecisionOutputTime value may be set, for example, to the currentTime value when an output is produced.

In step 541, the process determines whether the time since the previous optimization decision is greater than an optimization decision rate. The decision rate may be a fixed value or may be dynamically determined. If the time since the previous optimization decision is greater than the optimization decision rate, the process continues to step 552; otherwise, the process continues to step 554.

In step 552, the process sets a timerLength value to a small value. The small value, for example, two seconds, allows related triggering events to be received before an optimization decision is produced. The small value may be a fixed value or may be dynamically determined. A dynamic value may be, for example, based on the triggering event. The process continues to step 556.

In step 554, the process determines the timerLength value to the time remaining for the optimization decision rate. The process may, for example, set the timerLength value to equal a decisionRate value minus a timeSinceLastDecision value, where decisionRate is the optimization decision rate and lastDecisionOutputTime is the time when the previous decision output was produced. For example, if the DecisionRate is once per hour and the last decision was output 45 minutes ago, the timer duration will be set to 15 minutes.

In step 580, the process set the decision timer using the timerLength value from step 552 or step 554. A decision output can then be produced when the decision time expires. Thereafter the process returns.

An optimizer module may provide improved performance by waiting to gather data for some time after startup before producing optimization decisions. The timing of initial optimization decisions may be changed by, for example, setting the initial value of the lastDecisionOutputTime. A process can begin with the lastDecisionOutputTime set to value older than the current time to produce relatively early optimization decisions or with the lastDecisionOutputTime set to value newer than the current time to produce relatively late optimization decisions.

FIG. 6 is a flowchart of a process for producing optimization decisions. The process of FIG. 6 may be used in conjunction with the process of FIG. 5. The process for producing optimization decisions may begin when a decision timer expires 610. The decision timer may be set as described for steps 552-556 of the process of FIG. 5.

In step 630, the process evaluates the data available to the optimization module. The evaluation may be unique to the particular optimization performed. The evaluation may be incremental to data that has changed since a prior optimization decision.

In step 641, the process uses the evaluation of step 630 to determine whether a new optimization decision is to be made. The determination may be based, for example, on an amount of change between current and possible new optimized parameters. The process may determine to not make an optimization decision, for example, if the optimization module has not received sufficient input data or if the input data is out of date or invalid. If a new optimization decision is to be made, the process continues to step 652; otherwise, the process returns.

In step 652, the process supplies information about the optimization decision to affected modules. The optimization decision may include changes to configuration parameters of data model used by the optimizer module. The process may save the configuration parameters for subsequent use. The parameters may also be supplied to other modules, for example, via observer modules.

In step 656, the process sets the last decision output time value (lastDecisionOutputTime) to the current time (currentTime). Thereafter the process returns.

Tracking Area Optimizer

Returning to FIG. 3, the tracking area optimizer module 331 can switch the associated cell between tracking areas. Tracking areas are logical groups of cells that can be used in tracking the location of user equipment. The cell bears a communication overhead burden for its tracking area. There can be signaling using, for example, the paging channel to page idle user equipment in the tracking area and using the random access channel (RACH) for tracking area updates when user equipment move in and out of the tracking area.

The tracking area optimizer module 331 can work to minimize the resources allocated to RACH and paging channel usage. Accordingly, tracking area optimizer module 331 may monitor the resource usage and switch the cell to a new tracking area if usage of either resource becomes excessive.

The tracking area optimizer module 331 can use RACH, paging, and handover information to make tracking area adjustments. The RRM module 343 may provide the information to the tracking area optimizer module 331, and the tracking area optimizer module 331 may communicate tracking area changes to the RRM module 343. When the tracking area optimizer module 331 determines that a change in tracking area is desired, the tracking area optimizer module 331 may select a new tracking area from multiple possible tracking areas. The selection may be based on the tracking area with the highest number of handovers.

The tracking area optimizer module 331, in an embodiment, uses RACH statistics from an LTE MAC_KPI_STATS_IND message. More specifically, the tracking area optimizer module 331 may use statistics indicating the number of received random access preambles. The tracking area optimizer module 331 may receive RACH statistics from the RACH optimizer module 332. The RACH statistics may be for multiple groups of user equipment that are summed. Additionally or alternatively, the tracking area optimizer module 331 may use other statistics that indicate communication for tracking area updates. The tracking area optimizer module 331, in an embodiment, uses paging statistics from an LTE RRC_OAM_GET_CELL_STATS_RESP message. The tracking area optimizer module 331 may use paging statistics indicating the numbers of successful and discarded pages. The statistics may cover, for example, an interval of 10 seconds. The statistics may cover periods whose durations are specified by the messages. The statistics received may be cumulative or may restart with each message with the SON module adjusting the values accordingly.

The tracking area optimizer module 331 also uses information about the tracking areas of neighbor cells. The tracking area optimizer module 331 can further use handover statistics from the neighbor cells. The neighbor cells' tracking areas and handover statistics may be received from the RRM module 343.

The tracking area optimizer module 331 filters the received statistics. For example, the tracking area optimizer module 331 may calculate time weighted averages of the statistics. The weighted may be, for example, uniform or may more overly weight more recent statistics. In an embodiment, the tracking area optimizer module 331 produces an average of the RACH loading and the paging loading. The filter may average, for example, 360 statistical values spanning one hour. The averages can then be compared to thresholds. When one of the thresholds is exceeded, the tracking area optimizer module 331 determines that a tracking area change should be made. When a tracking area change should be made, the tracking area optimizer module 331 may perform processes as generally illustrated in FIGS. 5 and 6.

The tracking area optimizer module 331, when a tracking area change should be made, determines which of the tracking area that neighbor cells of the associated cell are members of has processed the most handovers. Which of the cells has processed the most handovers, in various embodiments, may be judged based on incoming handovers, outbound handovers, handover to and/or from the associated cell, or other combinations. The tracking area optimizer module 331 may accumulate handover counts from all the cell's neighbors by tracking area. The tracking area with the most handovers (excluding the current tracking area of the cell) is selected as the new tracking area for the cell.

The tracking area optimizer module 331 may determine that there are no tracking areas available other than the tracking area that cell is already in. In this situation, the tracking area optimizer module 331 can signal an alarm. The tracking area optimizer module 331 is unable to change tracking area when no other tracking area is available.

After a new tracking area is selected, the tracking area optimizer module 331 can call a process to make the change. After the change is completed, the tracking area optimizer module 331 may save the old tracking area value and the time at which the change occurred. Additionally, any alarm for no tracking areas available can be cleared. The alarm can also be cleared when another tracking area becomes available. The alarm may also be cleared when the tracking area optimizer module 331 determines that a tracking area change is not needed.

The saved values may be used to detect that the tracking area is repeatedly switching between two tracking area. In this case, the tracking area optimizer module 331 signals an alarm to another module. Changing configuration parameters, for example, a decision threshold, may be used to resolve the repeated switching. The alarm may be cleared when the tracking area optimizer module 331 does not change tracking area for a certain time, for example, for two optimization decision times.

The configuration values used by the tracking area optimizer module 331, such as the filter weights and thresholds, may be configured via the COAM module 341.

When multiple cells are performing tracking are updates, it tracking area may go out of use. That is, all cells in a tracking area may move out of the tracking area. If this occurs, no cells will move back into that tracking area since it will not be in use by a neighbor cell. However, an operator may move cells to the out-of-use tracking area, for example, using OAM commands or via configuration file changes.

RACH Optimizer

The RACH optimizer module 332 can make RACH parameter adjustments to improve communication performance. The RACH optimizer module 332 may use RACH information from the RRM module 343 and the RACH optimizer module 332 may provide RACH parameters back to the RRM module 343. Example RACH parameters that may be configured by the RACH optimizer module 332 include RACH physical resources, RACH preamble allocation for different sets (e.g., dedicated, random-low, and random-high), RACH persistence level and backoff control, and RACH transmission power control

The RACH optimizer module 332 can work to tune the amount of physical resources dedicated for RACH operations per managed cell. The RACH optimizer module 332 may, for example, tune the RACH resources so as to reduce connection setup times while improving system capacity and terminal battery life. The RACH optimizer module 332 can work to achieve one or more goals. Example goals include maximizing the rate of successful Random Access (RA) attempts, minimizing the number of RA re-transmissions per RA attempt, maximizing the amount of radio resources available for uplink data transmissions, minimizing the inter-cell interference caused by RACH transmissions, and minimizing the UE power output for RACH transmissions.

The RACH optimizer module 332 can process information about multiple types of information. The RACH optimizer module 332 can use information about preamble usage in its processing. The RRM module 343 may provide the information to the RACH optimizer module 332. For example, the RRM module 343 may inform the RACH optimizer module 332 of the number of dedicated preambles in use. When the demand for dedicated preambles is greater than the number of dedicated preambles available, the RRM module 343 can report the number needed in addition or alternatively to the number in use.

The RACH optimizer module 332 can also use information about RA attempts. For example, the RRM module 343 may inform the RACH optimizer module 332 of the number successful RA attempts, number of unsuccessful RA attempts, percentage of successful RA attempts, or other statistics. The RA statistics can be for each of multiple preamble groups. The RACH optimizer module 332 may use the RA statistics to estimate channel loading and to make decisions to adjust channel configuration and preamble split. The RACH optimizer module 332, in an embodiment, signals the RRM module 343 when to start reporting RA statistics and what interval to use for the statistics.

The RACH optimizer module 332 can also use information about RA attempts from UEs. The RRM module 343 may, for example, query a UE after an admission request to report on the number of RA preamble transmissions that were transmitted before successful completion of the RA operation. The UE may also report whether any of the retransmissions were due to collisions. The RRM supplies the information about RA attempts from the UE to the RACH optimizer module 332.

The RACH optimizer module 332 can use additional information, for example, detection of a new neighbor cell (including information about the configuration of the new neighbor cell), new configuration information of an existing neighbor cell (e.g., PRACH information), and indication that an existing neighbor cell is no longer considered to be a neighbor. Each of these may be supplied by the RRM module 343.

Additionally, the RACH optimizer module 332 may receive an indication of the creation of new cell managed by the local eNB. This may lead to a reset of RACH optimizer module. The RACH optimizer module 332 may also receive an indication that there is new configuration information for its associated cell. When there is new configuration information, the RACH optimizer module 332 may discard any optimization decisions and replace target RACH configuration values with the current managed cell values.

The RACH optimizer module 332 can produce several different outputs. The RACH optimizer module 332 can request the RRM module 343 change one or more of its configuration values. The RACH optimizer module 332, in an embodiment, passes a data structure containing RACH configuration values to the RRM module 343. The RRM module 343 determines what values have changed (if any) and signals the LTEIF module 349 accordingly. The RRM module 343 may also signal the COAM module 341 to update its data model to reflect the changes.

The RACH optimizer module 332 can request the RRM module 343 to use a certain interval for its RACH statistics reports. RRM module 343 may also be requested to begin periodic statistical reporting. Similarly, RACH optimizer module 332 can request the RRM module 343 to stop periodic statistical reporting. The RACH optimizer module 332 can request the RRM module 343 to supply the current RACH parameters in use in a managed cell.

The RACH optimizer module 332 can also supply information to the CNIPM module 345. The RACH optimizer module 332 may inform the CNIPM module 345 when parameters related to PRACH are changed. The CNIPM module 345 can then communicate changed parameters to relevant neighbor cells.

The RACH optimizer module 332 filters the received statistics. For example, the RACH optimizer module 332 may calculate time weighted averages of the statistics. The weights may be, for example, uniform or may more overly weight more recent statistics. In an embodiment, the RACH optimizer module 332 produces an average of the RACH loading and the paging loading. The filter may average, for example, 360 statistical values spanning one hour. The averages can then be compared to thresholds. When one of the thresholds is exceeded, the RACH optimizer module 332 determines that parameter changes should be made. When changes should be made, the RACH optimizer module 332 may perform processes as generally illustrated in FIGS. 5 and 6.

The configuration values used by the RACH optimizer module 332, such as the filter weights and thresholds, may be configured via the COAM module 341.

When multiple cells are performing tracking are updates, a tracking area may go out of use. That is, all cells in a tracking area may move out of the tracking area. If this occurs, no cells will move back into that tracking area since it will not be in use by a neighbor cell. However, an operator may move cells to the out-of-use tracking area, for example, using OAM commands or via configuration file changes.

The RACH optimizer module 332, in an embodiment, maintains two instances of an RachConfiguration structure for the managed cell that the optimizer is operating on. One instance is a ‘source’ instance that represents the current managed cell configuration and the other instance is a ‘target’ instance which holds desired changes that the RACH optimizer module 332 desires to make. The SON module may invoke a ( ) call for RACH optimizer module 332 that compares the two structures. If source instance differs from the target instance, then the RACH optimizer module 332 copies values from the target instance into the source instance and makes appropriate CREAM component calls to apply the new RACH values. If the source instance does not differ from the target instance, no further action is taken.

The RACH optimizer module 332 may have an interface that uses a group A/group B preamble split that is set based on a rate of preamble usage as reported in the MAC statistics. A side effect of operation of the RACH optimizer module 332 may be that the number of group B preambles is set to zero and will stay at zero until manually increased. This is due to no UEs being able to select group B in this case. The size of certain messages (e.g., Message3) transmissions received could also be an input into the preamble split decision.

The RACH optimizer module 332 may adjust values using information on the size of Message3 transmissions and the preamble group of a UE's most recent successful RA attempt (which can then be matched up with preamble transmission counters reported by the UE) as inputs. The RACH optimizer module 332 may also adjust values using HARQ failure information for Message3 from the UEs. Further, values may be adjusted using information on UE speeds (e.g., based on Doppler shift information) in the cell. The RACH optimizer module 332 may also adjust values using as a function of the maximum expected transmission delay from UE to base station. This delay can be estimated from the configured cell size provided in the data model. The SON module may obtain information for the UEs using, for example, UEInformationRequest and UEInformationResponse messages.

The RACH optimizer module 332 may include a function to adjust preamble transmit power. The RACH optimizer module 332 may adjust the desired preamble transmit power using the RACH statistics reported by the user equipment. The adjustment may be made to adjust the preamble transmit power such that it is near the lowest level that results in detection of the first preamble transmission. UE reports where collisions occurred may be ignored by this function. This can be done based on the likely reason for preamble retransmission without collisions is due to a failure of the eNB to detect the preamble. The RACH optimizer module 332, for example, adjusts the power upward as needed based on the power used for successful preamble transmissions. The RACH optimizer module 332 may periodically adjust the power downward, for example, to test for improved detection conditions.

The RACH optimizer module 332 may include a function to select preambles for use in the associated cell. The selection may be based on having a minimal overlap with the preambles used in neighboring cells. For each known neighbor (e.g., cells in a neighbor list), the RACH optimizer module 332 collects information about RACH preamble use. In an embodiment, the RACH optimizer module 332 collects a root sequence index, a zero correlation zone index, and a high speed flag for the neighbor cells (or default values or other place holders if the information is not available).

The available preamble set is generally split into two partitions: a dedicated partition and a shared partition. Preambles in the dedicated partition are available for use in contention-free RA operations; preambles in the shared partition available for use in contention-based RA. Increasing the size of one partition decreases the size of the other partition.

The function to select preambles can work to adjust the relative sizes of the two partitions. The RACH optimizer module 332 may increase the number of dedicated preambles based on preamble usage reports from the RRM module 343. The RACH optimizer module 332 may increase the number of shared preambles based on the rate of RA collisions. The rate of RA collisions information can be derived from the UE reported information received through the RRM module 343.

The RACH optimizer module 332 may determine that it would be desirable to increase the size of both partitions. In an embodiment, the RACH optimizer module 332 may make no change to the partitions in this situation. In another embodiment, the RACH optimizer module 332 may use priority weightings to determine which partition to increase in this situation.

The RACH optimizer module 332 may begin with the dedicated partition set based on configuration parameter that indicates an average number of dedicated preambles needed. The RACH optimizer module 332 may also begin with a model value that corresponds to a low rate of collisions. The average number of dedicated preambles needed may be a historical value. The RACH optimizer module 332 can use minimum size limits for both partitions.

The RACH optimizer module 332 may include a function to select a PRACH slot configuration. The configuration may be selected from a table of choices, for example, Table 5.7.1-2 in 3GPP TS 36.211. The RACH optimizer module 332 may base the selection on RACH load and to minimize overlap with neighboring cells. The RACH load used may be based on RA statistics. The selection functions can be triggered when RACH statistics are received, addition of a new neighbor, or a configuration changes of an existing neighbor.

The RACH optimizer module 332, in an embodiment, sums the preambles statistics for all categories to produce a sample for computing an average number of preambles received per second (avePreambleRate). The RACH optimizer module 332 uses the average number of preambles received per second to select a target operating class. The class may be selected from a table such as the example in Table 1. The RACH optimizer module 332 selects the class with the lowest corresponding value from the ‘Max Rate’ column of the table that is >=avePreambleRate and is valid for the preamble format used. If avePreambleRate is greater than the highest available rate for a preamble format then the operating class of the highest rate possible for the format is used.

TABLE 1
RACH Operating Classes

| Operating | Supported | | Max Rate |
|---|---|---|---|
| Class | Preamble Format | Base Index | (preambles/sec) |
| A | 0, 1, 2, 3 | 0, 1, 2, 15 | 800 |
| B | 0, 1, 2, 3 | 3, 4, 5 | 1600 |
| C | 0, 1, 2, 3 | 6, 7, 8 | 3200 |
| D | 0, 1, 2, 3 | 9, 10, 11 | 5333 |
| E | 0, 1, 2 | 12, 13 | 8000 |
| F | 0 | 14 | 16000 |

After selecting a target operating class, the RACH optimizer module 332 creates an empty sorted interval list for each possible base index for that class. For example, class A would have four lists (one each for indices 0, 1, 2, and 15) and class F would have only one list (for index 0). For intervals used with these lists, interval.first=PRACH-FrequencyOffset and interval.last=PRACH-FrequencyOffset+6. For each neighbor cell, an interval is created using the PRACH-FrequencyOffset configured for that cell. The PRACH-ConfigurationIndex for the cell is then converted to a Base Index: Base Index=PRACH-ConfigurationIndex mod 16.

A table such as example Table 2 may be used to map the resulting base index to a set of conflicted base indices. For each index in the conflict set, the interval is added to the corresponding Sorted Interval List if one exists for the target operating class identified for the managed cell.

TABLE 2
Base Index Conflicts

| Base | |
|---|---|
| Index | Base Index Conflicts |
| 0 | 0, 3, 6, 9, 13, 14 |
| 1 | 1, 4, 9, 12, 14 |
| 2 | 2, 5, 7, 9, 13, 14 |
| 3 | 0, 3, 6, 9, 13, 14 |
| 4 | 1, 4, 9, 12, 14 |
| 5 | 2, 5, 7, 9, 13, 14 |
| 6 | 0, 3, 6, 9, 11, 12, 13, 14 |
| 7 | 2, 5, 7, 9, 10, 12, 13, 14 |
| 8 | 8, 10, 11, 12, 13, 14 |
| 9 | 0, 1, 2, 3, 4, 5, 6, 7, 9, 13, 14 |
| 10 | 7, 8, 10, 12, 13, 14 |
| 11 | 6, 8, 11, 12, 13, 14, 15 |
| 12 | 1, 4, 6, 7, 8, 9, 10, 12, 11, 14 |
| 13 | 0, 2, 3, 5, 6, 7, 8, 9, 10, 11, 13, 14, 15 |
| 14 | 0, 1, 2, 3, 4, 5, 6, 7, 8, 9, 10, 11, 12, 13, 14, 15 |
| 15 | 11, 13, 14, 15 |

The filled sorted interval lists can be used to search for a <frequencyOffset, base index> pair that results in minimal overlap using the lowest valued frequency offset. Using the preamble format (e.g., set by the operator and/or cell size measurement), the base index is converted to a PRACH configuration index. The new configuration index and frequency offset are then sent to the RRM to be applied to the managed cell.

Mobility Optimizer

The mobility optimizer module 333 implements a mobility optimization algorithm that uses radio link failure and handover information to make mobility parameter adjustments and communicate them to RRM. The SON module receives radio link failure and handover failure information from the RRM module, concerning the local eNB's cells. The SON module receives radio link failure and handover report information from remote eNBs, through an LTEIF Observer. The handover failure types evaluated by the Mobility Optimizer include: Early handovers, Late handovers, and Incorrect Target (e.g. an ANR add case).

The mobility optimizer module 333 can operate to reduce handover failure rates. The mobility optimizer module 333 may tune handover parameters, for example, to reduce early handovers, late handovers, and handovers to incorrect targets. The mobility optimizer module 333 may also send MOBILITY_CHANGE_REQUESTs to an inter-small cell management (CNIPM) module at a remote eNB.

Load Balancer

The load balancer module 334 can operate to balance resource loading between the base station and its neighboring base stations. Examples of balanced resources include processor usage, network traffic usage, and radio resource usage. The load balancer module 334 receives information from RRM regarding loading of the local base station. The local resource usage information can be transmitted to remote eNBs, for example, via the passes to the CNIPM module. Similarly, the SON module receives resource usage information from remote eNBs, for example, through an LTEIF observer. The load balancer module 334 may consider QoS in making its load balancing decisions.

Example load balancing decisions include activating or deactivating cells, barring (e.g., to not accept bearers) or unbarring cells, initiating handovers, altering handover parameters, and modifying idle reselection parameters. The load balancing decisions are communicated to the RRM module if they concern the local base station. The load balancing decisions may be communicated to remote eNBs over the X2 interface, for example, via the LTEIF module.

The SON module may also receive requests, for example, cell activation requests, from remote eNBs. The requests are evaluated by the load balancer module 334. If the requests are approved, the requests can be forwarded to the RRM module. A response, for example, indicating success or failure of the request, may be returned to the requesting eNB.

An example embodiment of a load balancer module will now be described in further detail. The example load balancer module performs a resource status update procedure whenever resource status update events are received from peers. The load balancer module 334 maintains a state of filtered resource values for each neighbor. During resource status update procedure the state of each neighbor managed by the peer is updated with the inputs.

The load balancer module 334 may use a filterCellResourceCapacity common procedure whenever a local resource status update event is received. Upon receiving either a local or remotely generated resource status update the load balancer module 334 can use the filterCellResourceCapacity procedure to process the input values. Each PRB usage and capacity available parameter contained in the resource status update can be individually filtered.

The load balancer module 334 can use an optimizer base class that determines that when a load balancing decision will be made. When a load balancing decision is to be made, the load balancer module 334 shall examine the current filtered state of all state parameters maintained by the load balancer module 334.

The load balancer module 334, during the decision making procedure, calculates the available best effort and guaranteed bitrate capacity of the cell being managed. These capacities are used as inputs to adjust the radio admission state of the cell and the parameters for handovers to each of the adjacent neighbors.

When calculating the available best effort capacity, the load balancer module 334 generally uses the latest filtered usage information, for example, for transport network load, L2/L3 processor load, and managed cell resource capacity input values. These values may be aggregated together to generate a single availableCapacity number.

When calculating the available guaranteed bitrate capacity the load balancer module 334 generally uses use the latest guaranteed bit rate PRB usage filtered results from the local cell resource capacity input values. These values may also be aggregated together to a single gbrAvailableCapacity number.

When adjusting the handover parameters for a neighbor, the load balancer module 334 can calculate the available best effort capacity of the neighbor and use this value to derive the handover parameter values based on the configured thresholds and the current serving cell capacity available.

The load balancer module 334 can include an adjust radio admission state procedure, where the load balancer module 334 evaluates the calculated best effort and guaranteed bit rate capacity available to determine the current RAC state of the managed cell.

Inter-Cell Interference Coordinator (ICIC)

The inter-cell interference coordinator (ICIC) module 335 implements an ICIC algorithm based on X2 features that provide the needed information. The inter-cell interference coordinator (ICIC) module 335 receives load information from RRM, concerning the local eNB. The inter-cell interference coordinator (ICIC) module 335 receives load information from remote eNBs, through an LTEIF observer. The ICIC algorithm makes decisions regarding Physical Resource Block (PRB) allocation, and communicates them to the RRM module.

Further functions of an implementation of a SON module may include the module communicating with the LTEIF module to receive X2 information from remote eNBs, makes cell activation requests to remote eNBs, and responds to activation requests from them. Decisions and configuration changes may be produced by a per-cell instance of a SON algorithm which may be metered at a maximum rate of occurrence configurable via the data model. The SON Optimizers can detect alarm conditions that are defined for them. The SON Optimizers may also notify COAM when alarms are raised or cleared. A SON module for a cell can have the ability to operate in a “test mode,” in which it logs intended decisions without sending decision commands to the other CREAM components.

As described in this specification, various apparatuses and methods are described as working to optimize particular parameters, functions, or operations. This use of the term optimize does not necessarily mean optimize in a theoretical or global sense. Rather, the apparatuses and methods may work to improve performance using algorithms that are expected to improve performance in at least many common cases. Similar terms like minimize or maximize are used in a like manner.

Those of skill will appreciate that the various illustrative logical blocks, modules, units, and algorithm steps described in connection with the embodiments disclosed herein can often be implemented as electronic hardware, computer software, or combinations of both. To clearly illustrate this interchangeability of hardware and software, various illustrative components, units, blocks, modules, and steps have been described above generally in terms of their functionality. Whether such functionality is implemented as hardware or software depends upon the particular system and design constraints imposed on the overall system. Skilled persons can implement the described functionality in varying ways for each particular system, but such implementation decisions should not be interpreted as causing a departure from the scope of the invention. In addition, the grouping of functions within a unit, module, block, or step is for ease of description. Specific functions or steps can be moved from one unit, module, or block without departing from the invention.

The various illustrative logical blocks, units, steps and modules described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, or microcontroller. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm and the processes of a block or module described in connection with the embodiments disclosed herein can be embodied directly in hardware, in a software module (or unit) executed by a processor, or in a combination of the two. A software module can reside in RAM memory, flash memory, ROM memory, EPROM memory, EEPROM memory, registers, hard disk, a removable disk, a CD-ROM, or any other form of machine or computer readable storage medium. An exemplary storage medium can be coupled to the processor such that the processor can read information from, and write information to, the storage medium. In the alternative, the storage medium can be integral to the processor. The processor and the storage medium can reside in an ASIC.

Various embodiments may also be implemented primarily in hardware using, for example, components such as application specific integrated circuits (ASICs), or field programmable gate arrays (FPGAs). Implementation of a hardware state machine capable of performing the functions described herein will also be apparent to those skilled in the relevant art. Various embodiments may also be implemented using a combination of both hardware and software.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter, which is broadly contemplated by the present invention. It is further understood that the scope of the present invention fully encompasses other embodiments that may become obvious to those skilled in the art.

### ACRONYMS AND ABBREVIATIONS

The foregoing description uses many terms, acronyms, and abbreviations that are common in the arts related to wireless communications. To aid those who may be less familiar with the relevant arts in understanding the disclosed systems and methods, the table below lists definitions for many acronyms and abbreviations used in this application.

| Term/ | |
|---|---|
| Acronym | Definition |
| ACS | Automatic Configuration System |
| API | Application Programming Interface |
| BSS | Base Station System |
| CDMA | Code Division Multiple Access |
| CNM | Core Network Management |
| eNB | Evolved Node B |
| ECGI | Enhanced Cell Global Identity |
| EPC | Evolved Packet Core |
| ERDSS | External Radio Device Support System |
| FAPI | Femto Application Platform Interface |
| GUI | Graphical User Interface |
| HOM | Handover Margin |
| IPM | Inter Pico cell Management |
| IDE | Integrated Development Environment |
| LTE | Long Term Evolution |
| MME | Mobility Management Entity |
| MP | Mobility Processor |
| NeNB | Newport Evolved Node B (CREAM-enabled picocell) |
| NMM | Network Monitor Mode |
| OAM | Operations, Administration, and Maintenance |
| OAM-GUI | Operations, Administration, and Maintenance Graphical |
| | UI |
| OAM-TR069 | Operations, Administration, and Maintenance TR069 |
| | Protocol |
| OAM-TUI | Operations, Administration, and Maintenance Textual UI |
| PCI | Physical Cell Identity |
| PRACH | Physical Random Access Channel |
| PRB | Physical Resource Block |
| QoS | Quality of Service |
| RAB | Radio Access Bearer |
| RACH | Random Access Channel |
| RAT | Radio Access Technology |
| RF | Radio Frequency |
| RRC | Radio Resource Control |
| S-GW | Servicing Gateway |
| SCM | Source Code Management |
| SDD | Software Design Description |
| SDP | Software Development Plan |
| SGSN | Serving GPRS Support Node |
| SON | Self-Organizing Network |
| SRS | Software Requirements Specification |
| S1AP | S1 Application |
| TAI | Tracking Area Identity |
| TUI | Terminal User Interface |
| TTT | Time-To-Trigger |
| UE | User Equipment |
| UML | Unified Modeling Language |
| UMTS | Universal Mobile Telecommunications Service |
| X2AP | X2 Application |

What is claimed is:

1. A base station, comprising:
a plurality of radio devices operable to establish wireless communications with user equipments;
a backhaul interface module configured to send data to a core network and receive data from the core network; and
a common radio element application manager (CREAM) module configured to manage communications between the user equipments and the core network via the radio devices and the backhaul interface, the CREAM module including a self-organizing network module configured to configure the base station to operate in a self-organizing network.

2. The base station of claim 1, wherein the self-organizing network module includes a tracking area optimizer module configured to automatically assign one more cells served by the base station to tracking areas.

3. The base station of claim 2, wherein the one or more cells are assigned to tracking areas minimize the resources allocated to a random access channel.

4. The base station of claim 2, wherein the one or more cells are assigned to tracking areas to minimize paging channel usage.

5. The base station of claim 1, wherein the self-organizing network module includes a random access channel (RACH) optimizer module configured to automatically configure RACH parameters to optimize communication performance.

6. The base station of claim 5, wherein the RACH optimizer module is further configured to maximizing a rate of successful random access (RA) attempts.

7. The base station of claim 1, wherein the self-organizing network module includes a mobility optimizer module configured to use radio link failure and handover information to optimize mobility parameters.

8. The base station of claim 1, wherein the self-organizing network module includes a load balancer module configured to optimize allocation of communication resources.

9. The base station of claim 8, wherein the load balancer module is further configured to optimize allocation of communication resources taking into account resource statuses from neighbor cells.

10. The base station of claim 1, wherein the self-organizing network module includes an inter-cell interference coordinator (ICIC) module configured to automatically optimize inter-cell interference.

11. The base station of claim 1, wherein the plurality of radio devices are operable to establish wireless communications with user equipments in multiple cells, and wherein the self-organizing network module includes a per-cell self-organizing network module for configuring each of the cells to operate in a self-organizing network.

12. A base station, comprising:
one or more radio modules, each of the radio modules operable to establish wireless communications with user equipments using one or more managed cells;
a backhaul interface module configured to send data to a core network and receive data from the core network;
a processor; and
a memory coupled to the processor and storing instructions for execution by the processor, the instructions comprising a self-organizing network module that when executed by the processor configures the base station to operate in a self-organizing network.

13. The base station of claim 12, wherein the self-organizing network module includes a tracking area optimizer module that when executed by the processor automatically assign one more cells served by the base station to tracking areas.

14. The base station of claim 13, wherein the one or more cells are assigned to tracking areas minimize the resources allocated to RACH.

15. The base station of claim 12, wherein the one or more cells are assigned to tracking areas to minimize paging channel usage.

16. The base station of claim 12, wherein the self-organizing network module includes a random access channel (RACH) optimizer module that when executed by the processor automatically configures RACH parameters to optimize communication performance.

17. The base station of claim 16, wherein the RACH optimizer module further includes instructions that when executed by the processor maximize a rate of successful random access (RA) attempts.

18. The base station of claim 12, wherein the self-organizing network module includes a mobility optimizer module that when executed by the processor uses radio link failure and handover information to optimize mobility parameters.

19. The base station of claim 12, wherein the self-organizing network module includes a load balancer module that when executed by the processor optimizes allocation of communication resources.

20. The base station of claim 19, wherein the load balancer module further includes instructions that when executed by the processor optimize allocation of communication resources taking into account resource statuses from neighbor cells.

21. The base station of claim 12, wherein the self-organizing network module includes an inter-cell interference coordinator (ICIC) module that when executed by the processor automatically optimizes inter-cell interference.

22. The base station of claim 12, wherein the plurality of radio devices are operable to establish wireless communications with user equipments in multiple cells.
